(19) United States
(12) Patent Application Publication
(10) Pub. No.: US 2002/0037452 A1
(43) Pub. Date: Mar. 28, 2002

(54) Novel compositions for use in batteries, capacitors, fuel cells and similar devices and for hydrogen production

(76) Inventor: David G. Schmidt, Dahlonega, GA (US)

Correspondence Address: John K. McDonald, Ph.D., KILPATRICK STOCKTON LLP, 2400 Monarch Tower, 3424 Peachtree Road, N.E., Atlanta, GA, 30326, US

(21) Appl. No.: 09/887,531

(22) Filed: Jun. 22, 2001

Related U.S. Application Data
(60) Provisional application No. 60/213,395, filed on Jun. 23, 2000.

(51) Int. Cl. H01M 4/46; H01M 10/26; H01M 4/58; H01M 4/62; C01B 3/08; C22C 21/00; H01M 8/08; H01M 8/06; H01G 9/035; H01G 9/045; H01M 4/36

(52) U.S. Cl. 429/218.1; 429/206; 429/221; 429/223; 429/232; 423/657; 420/528; 429/46; 429/19; 361/504; 361/509

(57) ABSTRACT

This invention provides novel chemical compositions, for use as electrode and electrolyte materials and for hydrogen production, methods for making these compositions, and methods of using these compositions in a variety of applications. The new compositions of the present invention comprise: one or more transition metal compounds; aluminum; and either at least one soluble base or at least one soluble electrolyte in contact with the aluminum. The present invention may also comprise one or more elements and/or compounds having high mobility values for electrons, in some applications. This composition is useful as novel electrode/electrolyte components in devices such as batteries, capacitors, fuel cells and similar devices, and also useful in the direct production of hydrogen gas.

### PRIOR RELATED APPLICATIONS

This application claims priority to U.S. provisional application serial No. 60/213,395, filed Jun. 23, 2000.

### TECHNICAL FIELD OF THE INVENTION

The present invention provides new chemical compositions, including new electrode and electrolyte materials, methods for making these compositions, and methods of using these compositions in a range of energy-related applications, including batteries, capacitors, fuel cells and similar devices. The novel compositions of the present invention are also used as a source of hydrogen gas.

### BACKGROUND OF THE INVENTION

New chemical compositions, including new electrode and electrolyte materials, are useful in enhancing the performance of batteries, capacitors, fuel cells, and similar devices. Because one principal application of new alloys is in electrode materials, advancements in energy production have paralleled developments in alloy performance. Electrodes may function in many ways, and numerous electrode materials are available for specific applications. For example, primary batteries often use electrodes comprising zinc as a principal component. In this case, the zinc electrode serves as a source of electrons, but once all the zinc has been oxidized, the primary battery is exhausted. Therefore, any primary battery system stops working and must be discarded after one of its chemicals has been depleted. The total amount of energy produced by this type of primary battery system depends upon how much active material is contained within the battery.

Capacitors are devices that store electrical energy and then rapidly discharge that energy when required. Electrode materials play a key role in capacitor performance. For example, the aluminum electrolytic capacitor, as disclosed in U.S. Pat. No. 5,448,448, represents a typical electrolytic capacitor. Great emphasis is placed on the voltage rating of the capacitor as well as its ability to store electrons (rated in Farads). In certain applications, there would be great advantage for the capacitor to be able to both rapidly generate and also discharge energy. The majority of capacitors found in the prior art do not possess both of these attributes.

Another type of electrode is used in fuel cells. A fuel cell operates as a galvanic cell wherein one of the reactants is a fuel, such as hydrogen or methane. One such fuel cell system is disclosed in U.S. Pat. No. 5,962,155. Fuel cells may operate using platinum electrodes or porous carbon electrodes containing metal catalysts. In contrast to the electrodes of a primary battery, fuel cell electrodes are not the source of electrons but serve primarily to interact with the fuel and to shuttle electrons through the cell. A fuel cell reactant is not contained within the cell, but must be continuously supplied from an external source. Although fuel cells show great promise as a replacement to some portable energy sources, the cost and the problems associated with the storage and delivery of fuels such as hydrogen have prohibited their widespread use.

An associated problem in energy technology, especially related to fuel cell operation, is that of generating and storing hydrogen gas. The use of hydrogen gas as a fuel is environmentally advantageous, because hydrogen bums in the presence of oxygen to yield water as a by-product. The dominant industrial process for producing hydrogen is the catalytic steam-hydrocarbon reforming process using natural gas (largely methane) or oil-refinery feedstocks at high temperatures (e.g. 900° C.). Hydrogen gas is stored in compressed gas cylinders for transport and use elsewhere. On a smaller scale, hydrogen gas may be produced by the well-known electrolysis method, but energy must be supplied from other sources for this process. The reaction of acid with many metals produces hydrogen gas, but this method is more useful in small scale applications and is not economically feasible. Another means for generating hydrogen gas is to store the hydrogen in the form of a metal hydride. While this technology stores hydrogen more safely than in compressed gas tanks, after the hydrogen is consumed, the metal hydride must again be recharged with hydrogen gas.

What is needed are new methods to generate hydrogen. What is also needed is a method to store and utilize hydrogen safely for energy production in locations where it may be used for combustion, fuel cell operation, or other energy applications. What is also needed are new and better chemical compositions, including new electrode alloys/electrolyte systems that exceed the performance capabilities of those currently used in devices such as batteries, capacitors, and fuel cells. What is also needed is a hybrid electrode that could serve more than one energy production function, such as a hybrid fuel cell using electrodes for both hydrogen production and electron transfer functions.

### SUMMARY OF THE INVENTION

The present invention provides new chemical compositions, methods for making these compositions, and methods of using these compositions in a variety of energy-related applications. The compositions of the present invention may be used as electrode and electrolyte materials in applications such as batteries, capacitors, fuel cells and similar devices, as well as for hydrogen gas production.

The new compositions of the present invention comprise: (A) one or more transition metal compounds; (B) aluminum; and (C) either at least one soluble base or at least one soluble electrolyte in contact with the aluminum. The present invention may also comprise another component, (D) one or more elements and/or compounds having high mobility values for electrons, in some applications. Thus, components A, B, and C are required components of the present invention. Some applications optionally incorporate component D.

Component A of the compositions of the present invention comprises one or more transition metal compounds, i.e. compounds of the groups 1B, 2B, 3B, 4B, 5B, 6B, 7B, and 8B metals of the periodic table. It is not necessary that these compounds be highly soluble in water for them to be effective in the operation of this invention. Preferably, component A comprises one or more compounds of the group 8B transition metals iron, ruthenium, osmium, cobalt, rhodium, iridium, nickel, palladium or platinum. More preferably, the composition of the present invention comprises one or more compounds of nickel, palladium or platinum. More preferably still, the composition of the present invention comprises one or more compounds of nickel. Transition metal compounds of nickel are preferred for several reasons, including their high catalytic activity and their relative cost as compared with other transition metal compounds.

The intended use of the composition of the present invention affects the selection of component C. Thus, when the composition is to be employed for the production of hydrogen gas, component C comprises a soluble base in contact with the aluminum or the alloy comprising aluminum and component D. When the composition is to be used as electrode and electrolyte materials in batteries or capacitors, component C comprises a soluble electrolyte in contact with the aluminum or the alloy comprising aluminum and component D. When the composition is to be used in fuel cells, a soluble base is employed, which serves as both electrolyte and reactant in the fuel cell.

When component C comprises a soluble base, hydroxide compounds are frequently selected for this component, including but not limited to LiOH, NaOH, KOH, RbOH, CsOH, Mg(OH)₂, Ca(OH)₂, Sr(OH)₂, and Ba(OH)₂, even though these compounds have varying solubilities. However, basic compounds other than hydroxides are also useful, such as aqueous solutions of Na₂CO₃, CaO or NH₃. When component C comprises a soluble electrolyte, soluble salts such as RbNO₃ and NaNO₃ are useful, as are soluble bases such as KOH, NaOH and Na₂CO₃. For fuel cell use, component C is selected to operate both as an electrolyte and a reactant in the fuel cell, and typically, compounds that provide hydroxide ion in solution are suitable.

The present invention is extremely versatile, because a single embodiment could be employed for both the production of hydrogen and for use in electrode alloys and electrolyte materials. For example, a soluble base such as KOH(aq) can be used as component C for either utility, because KOH(aq) also constitutes a soluble electrolyte. However, NaNO₃(aq) can only be used as the soluble electrolyte component C when this invention is used in batteries, capacitors, and similar devices, because aqueous NaNO₃ does not provide a basic solution.

Regardless of the use of the composition and independent of the nature of component C, there are at least two ways by which component A, the transition metal compound, is utilized in this invention. First, the transition metal compound may be in solution with component C, and this solution is then in contact with the aluminum or the alloy comprising aluminum and component D. Second, the transition metal compound may be present in solid form and admixed with the aluminum or the aluminum component D alloy. An example of a particularly useful component C is nickel hydroxide, which shows only slight solubility in water. However even a slight solubility is adequate for Ni(OH)₂ to be useful in the present invention.

Optional component D of the present invention comprises one or more elements and/or compounds having high mobility values for electrons. These elements and/or compounds are characterized by an electron mobility value from about 100 cm² V·s to about 100,000 cm²/V·s. When component D is included in the present invention, an alloy is typically formed from the aluminum and the high electron mobility component. When the composition is employed for the production of hydrogen, the alloy comprising aluminum and component D are placed in contact with the soluble base to form H₂ gas. When the composition is to be used as electrode and electrolyte materials in batteries, capacitors, fuel cells and similar devices, the aluminum and component D alloy comprise the anode of such devices. In those embodiments in which component D is not included, aluminum (component B) alone fulfills these functions and is used in the same manner as the alloy.

An examination of the metallurgical phase diagrams for aluminum and selected high electron mobility components, components B and D, suggests that large macrosegregation domains result from the limited solubilities of these components in their desired percentages. Therefore, the present invention also provides a method of manufacturing the alloys that reduces macrosegregation and improves homogeneity in an otherwise nonhomogeneous sample.

The alloys of the present invention are prepared by combining and melting the components of the alloy in a standard arc melting furnace, induction furnace, vapor deposition chamber, or sintering furnace, in ways known to one of ordinary skill in the art. In some embodiments of this invention, it is desirable to form intermediate or pre-melt alloys comprising a subset of the alloy components, and subsequently use the intermediate alloy(s) in a melting step together with the remaining alloy components. Typically, sufficient physical agitation accompanies the arc melting process to provide the preferred high sample homogeneity. While some physical agitation accompanies the induction melting process, it may or may not be necessary to apply additional physical agitation and/or sonication treatments to the melted sample to achieve the preferred high sample homogeneity. These treatments are made during the cooling step while the pre-melt alloy or final melt alloy sample is still in the liquid state.

The novel compositions of the present invention comprise: (A) one or more transition metal compounds; (B) aluminum; and (C) either at least one soluble base or at least one soluble electrolyte in contact with the aluminum. These novel reactant systems may further comprise (D) one or more elements and/or compounds having high mobility values for electrons, depending upon the desired application. Accordingly, one example of the present invention without component D comprises nickel hydroxide, aluminum, and potassium carbonate. In one embodiment, the nickel hydroxide and the potassium carbonate are in aqueous solution, and this solution is in contact with the aluminum. In another embodiment, the potassium carbonate is in aqueous solution, and this solution is in contact with an admixture of aluminum and nickel hydroxide.

One example of the present invention which includes component D comprises nickel hydroxide, aluminum, potassium carbonate, and germanium. In one embodiment, the nickel hydroxide and the potassium carbonate are in aqueous solution, and this solution is in contact with an alloy formed from the aluminum and the germanium. In another embodiment, the potassium carbonate is in aqueous solution, and this solution is in contact with an admixture of the aluminum-germanium alloy and the nickel hydroxide.

The compositions of the present invention have numerous potential uses, including, but not limited to, use as electrode and electrolyte materials in energy production and storage devices, and as materials for the production of hydrogen. Thus, the compositions of the present invention are useful as components of batteries, capacitors, fuel cells, hybrid battery/fuel cell designs, and the like. When used as an components in primary batteries, the compositions of the present invention overcome the limitations of prior art technologies by providing a battery with improved energy density compared to conventional primary battery systems.

The compositions of the present invention are also useful as electrodes and electrolyte materials in a capacitor device. The present invention overcomes the limitations of prior art technologies by allowing the capacitor to both store and generate electrical energy, unlike conventional capacitors which can only store energy. This improvement provides a capacitor with a greater energy density and more potential applications than currently available with conventional capacitor systems.

The compositions of the present invention are useful as electrode and electrolyte materials in a hybrid fuel cell device. The present invention overcomes the limitations of prior art technologies by allowing the alloys or aluminum of the composition to serve as both electrode and fuel source for the fuel cell device. This feature circumvents the need to provide hydrogen fuel separately, and has the advantage of using the fuel cell electrolyte as an electron transport medium. Such a fuel cell has a greater energy density and more potential applications than available with conventional fuel cell systems. Moreover, the alloy electrodes of the present invention are considerably less expensive than the platinum or platinum alloy electrodes of conventional hydrogen fuel cells.

The compositions of the present invention are useful for the production of hydrogen. In most reactions in which an alkali metal contacts water, hydrogen and heat energy are liberated very rapidly, sometimes explosively, because hydrogen formed may ignite as it is generated. In contrast, the alloy compositions of the present invention release hydrogen and energy over time, such as a period of a few hours to a few weeks when contacted with water. Thus, these alloy compositions overcome prior art limitations of producing hydrogen from basic solutions, typically prepared from alkali metal compounds and water, by sustaining and extending the release of hydrogen gas in a more controlled fashion. This feature also provides several advantages over other prior art methods for producing hydrogen. First, electricity is not needed to generate the hydrogen as in known electrolysis systems. Second, hydrogen gas is generated on demand when needed and not stored under high pressure in compressed gas tanks. Third, the compositions of the present invention liberate hydrogen gas more efficiently than conventional metal hydride storage systems.

Once generated, hydrogen gas may be used in various applications including, but not limited to, internal combustion engines, heating, ion propulsion, magnetohydrodynamics (MHD), fuel cells, welding, hydrogenation of oils, hydrogenation of petroleum and petrochemical fuels, hydrogenation of polymer related materials, reduction of organic compounds, reduction of inorganic and organometallic compounds, hydrogenation of volatile materials in vapor deposition processes, conventional jet propulsion, rocket fuel, and other applications.

In addition to the utility of the compositions in a fuel cell design described above, wherein the alloys or aluminum serve as both an electrode material and fuel source, the compositions of the present invention also serve as a fuel source for a conventional fuel cell. Because hydrogen is generated on demand, an advantage is gained over fuel cells that store hydrogen in compressed gas tanks or other means.

Accordingly, it is an object of the present invention to provide novel compositions.

Another object of the present invention is to provide compositions useful as electrode and electrolyte materials in devices such as batteries, capacitors, fuel cells and similar devices.

A further object of the present invention is to provide compositions that generate hydrogen gas.

It is an object of the present invention to provide compositions for the production of hydrogen or for use in fuel cells comprising: (A) one or more transition metal compounds; (B) aluminum; and (C) one or more soluble bases.

It is another object of the present invention to provide compositions for the production of hydrogen or for use in fuel cells comprising: (A) one or more transition metal compounds; (B) aluminum; (C) one or more soluble bases; and (D) one or more elements and/or compounds having high mobility values for electrons.

It is an object of the present invention to provide compositions for use in batteries, capacitors, and similar devices comprising: (A) one or more transition metal compounds; (B) aluminum; and (C) one or more soluble electrolytes.

It is yet another object of the present invention to provide compositions for use in batteries, capacitors, and similar devices comprising: (A) one or more transition metal compounds; (B) aluminum; (C) one or more soluble electrolytes; and (D) one or more elements and/or compounds having high mobility values for electrons.

Yet another object of the present invention is to provide alloys that produce hydrogen gas upon contact with aqueous base solution, thereby providing alloys that may be used in numerous applications requiring hydrogen gas. These applications include, but are not limited to, internal combustion engines, heating, ion propulsion, magnetohydrodynamics (MHD), fuel cells, welding, hydrogenation of oils, hydrogenation of petroleum and petrochemical fuels, hydrogenation of polymer related materials, reduction of organic compounds, reduction of inorganic and organometallic compounds, hydrogenation of volatile materials in vapor deposition processes, conventional jet propulsion, rocket fuel, and other applications.

It is another object of the present invention to provide methods of making the novel alloys of the present invention.

Yet a further object of the present invention is to provide suitable methods of manufacturing the alloys of the present invention, including but not limited to, arc melting, induction melting, physical vapor deposition, chemical vapor deposition, and sintering.

A further object of the present invention is to provide alloys for use in a composition useful as electrode materials.

Another object of the present invention is to provide alloys for use in a composition useful as electrode materials in devices such as batteries, capacitors, fuel cells and similar devices.

A further object of the present invention is to provide alloys for use in a composition that generate hydrogen gas.

Another object of the present invention is to provide compositions and alloy compositions useful in a hybrid battery system.

Another object of the present invention is to provide compositions and alloy compositions useful as a fuel source in a fuel cell.

Yet another object of the present invention is to provide compositions and alloy compositions useful in a hybrid battery system where the alloys serve as both electrode and fuel source for the fuel cell device.

It is a further object of the present invention to provide a method of producing hydrogen that does not require the use of electricity.

Yet another object of the present invention is to provide a method of hydrogen production in which hydrogen gas is generated on demand when needed and is not stored under high pressure in compressed gas tanks.

These and other objects, features and advantages of the present invention will become apparent after a review of the following detailed description of some of the disclosed embodiments.

### BRIEF DESCRIPTION OF THE DRAWING

FIG. 1 illustrates the hydrogen production from the composition of Example 1 (labeled “NiOH”), as compared to hydrogen production from the same composition without nickel hydroxide (labeled “control”).

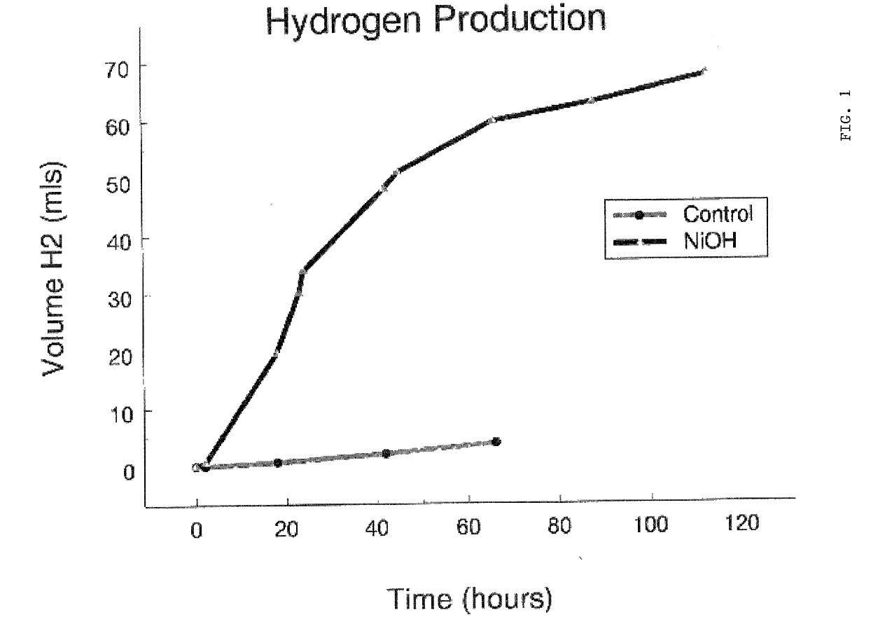

### DETAILED DESCRIPTION OF THE PRESENT INVENTION

The present invention provides new chemical compositions, methods for making these compositions, and methods of using these compositions in a wide variety of energy-related applications. The new compositions of the present invention comprise: (A) one or more transition metal compounds; (B) aluminum; and (C) either at least one soluble base or at least one soluble electrolyte in contact with the aluminum. The present invention may also comprise another component, (D) one or more elements and/or compounds having high mobility values for electrons, in some applications. Thus, components A, B, and C are required components of the present invention. Some applications optionally incorporate component D.

All of the compositions of the present invention may be used as electrode and electrolyte materials in a range of energy-related applications, including batteries and capacitors. Those embodiments comprising a soluble base can be used for hydrogen gas production and in fuel cells and similar devices. Thus, when the new composition is to be employed for the production of hydrogen gas, component C comprises a soluble base in contact with the aluminum. When the new composition is to be used as electrode and electrolyte materials in batteries or capacitors, component C comprises a soluble electrolyte in contact with the aluminum or aluminum component D alloy. When the new composition is to be used in fuel cells, a soluble base is employed, which serves as both electrolyte and reactant in the fuel cell.

One type of composition of the present invention comprises components A, B and C recited immediately above. Therefore, this type of composition comprises: (A) one or more transition metal compounds; (B) aluminum; and (C) at least one soluble base or at least one soluble electrolyte in contact with the aluminum. One example of this type of composition comprises (A) nickel hydroxide, (B) aluminum, and (C) potassium carbonate. In this embodiment, potassium carbonate can function as both a soluble base and a soluble electolyte. Typically, the potassium carbonate is in solution and the solution is in contact with the aluminum. The transition metal compound may either be in solution with the potassium carbonate, or admixed with the aluminum in solid form.

Another type of composition of the present invention comprises components A, B, C and D recited above. Therefore, this type of composition comprises: (A) one or more transition metal compounds; (B) aluminum; (C) at least one soluble base or a soluble electrolyte in contact with the aluminum; and (D) one or more elements and/or compounds having high mobility values for electrons. In this embodiment of the invention, the aluminum and high electron mobility component are formed into an alloy. One example of this type of composition comprises nickel hydroxide, aluminum, potassium carbonate, and germanium. Typically, the potassium carbonate is in solution and the solution is in contact with the aluminum-germanium alloy. The transition metal compound may either be in solution with the potassium carbonate, or admixed with the aluminum-germanium alloy in solid form.

The compositions are also designed to, among other things, release hydrogen gas in a controlled and useful fashion upon contacting the aluminum or alloys of aluminum and high electron mobility components with an aqueous solution comprising base. Therefore, these alloys may be used in many of the well-established applications for hydrogen gas, for example, in internal combustion engines, heating, ion propulsion, magnetohydrodynamics (MHD), fuel cells, welding, hydrogenation of oils, hydrogenation of petroleum and petrochemical fuels, hydrogenation of polymer related materials, reduction of organic compounds, reduction of inorganic and organometallic compounds, hydrogenation of volatile materials in vapor deposition processes, conventional jet propulsion, rocket fuel, and other applications.

The compositions and alloys of the present invention may also serve as both an electrode and a fuel source, and be used in various fuel cell configurations. The compositions and alloys of the present invention may also be used in a new capacitor which both stores and generates electrical energy. The present alloys are also useful as anode materials in a number of applications, such as in batteries, fuel cells, capacitors, and hybrid battery/fuel cell designs.

Definitions

In order to more clearly define the various terms as used herein, the following definitions are provided.

The terms “composition” and variations such as “chemical composition” are used in a general fashion herein to describe a system that comprises the components outlined above, namely: (A) one or more transition metal compounds; (B) aluminum; and (C) either at least one soluble base or at least one soluble electrolyte in contact with the aluminum. The present invention may also comprise another component, (D) one or more elements and/or compounds having high mobility values for electrons, in some applications. Thus, components A, B, and C are required components of the “composition” of the present invention, while some applications optionally incorporate component D in the “composition”. These terms are employed generally to describe the combination of components, regardless of whether the components are in solution or in solid form, and regardless of their use as electrode and electrolyte materials or for the production of hydrogen. The term “composition” is also used regardless of whether the electrode comprises aluminum or an alloy of aluminum and the high electron mobility component, and regardless of whether any catalytic activity for a particular combination of components exists or can be demonstrated.

The terms “alloy” and such variations as “alloy composition” are typically used herein to refer to the combination comprising components B and D of the present invention, that is, a combination of aluminum and a high electron mobility component.

The terms “transition metal” and such variations as “transition metal element” and “transition element,” as used herein, refer to the metals in groups 1B, 2B, 3B, 4B, 5B, 6B, 7B, and 8B, of the periodic table of elements, referring specifically to the elements scandium, yttrium, lanthanum, actinium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. These elements are specified either by their name or their standard one- or two-letter abbreviation.

Component A of the compositions of the present invention comprises one or more transition metal compounds. Thus, the terms “transition metal compound” and such variations as “transition metal salt” and “transition element compound,” as used herein, refer to covalent compounds, ionic compounds, polymeric compounds, cluster compounds, coordination compounds or salts, of any type whatsoever, of the transition metals described above. These elements are also described in the present application by their common one or two letter abbreviations known to one of ordinary skill in the art.

The terms “group 8 metal” or “group 8B metal,” as used herein, refer to the metals iron, ruthenium, osmium, cobalt, rhodium, iridium, nickel, palladium, and platinum.

The terms “group 1A alkali metal” and such variations as “group 1A metal” and simply “alkali metal,” as used herein, refer to the metals in group 1A of the periodic table, namely Li, Na, K, Rb, Cs, and Fr.

The terms “high electron mobility” element, compound, material, or component, and such variations as materials “having high mobility values for electrons” or “semiconductors,” as used herein, refer to species characterized by an electron mobility value from about 100 cm²/V·s to about 100,000 cm²/V·s. Examples of these species, which typically comprise semiconductor materials, include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, Te and combinations thereof.

Alloy Compositions

The compositions of the present invention, when configured as described herein, are designed to produce energy upon contacting either (B) aluminum, or alloys of (B) aluminum and (D) high electron mobility components, with an aqueous solution comprising base or electrolyte. The term energy production refers generally to the production of electrical energy and/or the production of hydrogen gas. Therefore, one aspect of the present invention is the combination of components to form alloys that will be used in the production and storage of energy.

The alloy compositions of the present invention are described by their components B and D, and the weight percentages of each component. It is to be understood that these recited percentages are percents by weight of each alloy component with respect to the weight of a final composition assumed to contain only these cited components. Thus, while additional components may be added to the alloys of the present invention, the stated weight percentages are relative to the portion of the final alloy containing only these components. It is to be understood that the inclusion of additional ingredients is encompassed within the present invention, depending upon the application for which a particular alloy is intended, provided the additional ingredients do not adversely affect the function of the alloy. It is also to be understood that the weight percentages recited herein include weights that are about 10% above or below the actual weight represented by that percentage.

In general terms, the alloys of the present invention comprise components B and D, that is, aluminum and one or more elements and/or compounds having high mobility values for electrons. An examination of the metallurgical phase diagrams for selected alloy components suggests that large macrosegregation domains will result from the limited solubilities of the components in their desired percentages. The present invention provides a method of manufacturing the alloys that reduces macrosegregation and develops homogeneity in an otherwise nonhomogeneous system.

In all the embodiments described herein, percentages are expressed by weight, unless otherwise specified. In general, the aluminum is present in an amount from about 5% to about 99% by weight of the alloy composition. The high electron mobility component is present in the alloy composition in an amount from about 1% to about 95% by weight. The amount of each component used in an embodiment of the alloy depends on, among other things, the anticipated use of that alloy. Guidelines for determining the amount of each component are provided below.

In one embodiment of the present invention, the alloy comprises the following components with their approximate weight percentages indicated, about 90% aluminum and about 10% germanium.

In another embodiment of this invention, the alloy comprises the following components with their approximate weight percentages indicated, about 36% aluminum, about 4% germanium, about 29.1% indium, and about 30.9% antimony.

In yet another embodiment of the present invention, the alloy comprises the following components with their approximate weight percentages indicated, about 40% aluminum, about 29.1% indium, and about 30.9% antimony.

In still another embodiment of the present invention, the alloy comprises the following components with their approximate weight percentages indicated, about 19.7% aluminum, about 20% antimony, about 18.8% indium, about 3.5% germanium, and about 38% tin.

The alloys of the present invention are prepared by combining and melting the components of the alloys in a standard arc melting furnace, induction furnace, vapor deposition chamber, or sintering furnace using techniques known to one of ordinary skill in the art. In some embodiments of this invention, it is desirable to form intermediate or pre-melt alloys comprising a subset of the alloy components, and subsequently use the intermediate alloy(s) in a melting step along with the remaining alloy components. Typically, sufficient physical agitation accompanies the arc melting process to provide the preferred high sample homogeneity. While some physical agitation accompanies the induction melting process, it may or may not be necessary to apply additional physical agitation and/or sonication treatments to the melted sample to achieve the preferred high sample homogeneity. These treatments are made during the cooling step while the pre-melt alloy or final melt alloy sample is still in the liquid state.

In order to produce hydrogen gas from the alloys of the present invention, the alloys are contacted with aqueous base. The alloy compositions of the present invention release hydrogen and energy over a period of a few hours to a few weeks when contacted with base in this fashion.

Selection of Composition Components

The examples contained herein are illustrative of the alloys of the present invention and are not to be construed as limiting in any way either the spirit or scope of the present invention.

Component A: Transition Metal Compounds

The compositions of the present invention comprise compounds of one or more of the transition metal elements, namely compounds of one or more of the groups 1B, 2B, 3B, 4B, 5B, 6B, 7B, and 8B elements. These elements include scandium, yttrium, lanthanum, actinium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Typically, the transition metal compound is present in solution together with the soluble base or soluble electrolyte, or admixed in solid form with the aluminum or the alloy. In the latter case, some transition metal compound dissolves in solution when the solution contacts the aluminum or the alloy, which is necessary for the invention to operate.

Preferably, the composition of the present invention comprises transition metal compounds of one or more of iron, ruthenium, osmium, cobalt, rhodium, iridium, nickel, palladium or platinum. More preferably, the composition of the present invention comprises transition metal compounds of one or more of nickel, palladium or platinum. More preferably still, the composition of the present invention comprises transition metal compounds of nickel. Transition metal compounds of nickel are preferred for several reasons, including their high catalytic activity and their relative cost as compared with other transition metal compounds. Examples of nickel-containing materials suitable for use in the present invention include, but are not limited to, nickel ammonium chloride, nickel ammonium sulfate, nickel bromide, nickel chloride, nickel formate, nickel hydroxide, nickel iodide, nickel nitrate, ammoniated nickel nitrate, nickel potassium sulfate, and nickel sulfate. A preferred nickel containing material for use in the compositions of the present invention is nickel hydroxide, Ni(OH)₂ (Aldrich Chemical Company, Milwaukee, Wis.). Nickel hydroxide occurs as a monohydrate of nickel oxide, and shows only slight solubility in water, however it is soluble in weakly acidic or basic solutions and is useful in the present invention.

Other transition metal compounds, particularly those of palladium, platinum or silver, are also useful either by themselves or in combination with nickel compounds. As circumstances change, such as the relative cost of a transition metal elements and their compounds, the use of other transition compounds may be preferred.

In one embodiment of the present invention, the transition metal compound may be added directly to the electrolyte solution, although its solubility need only be slight. In another embodiment, the transition metal compound is placed in intimate contact or admixed with the aluminum or the aluminum alloy in solid form. In either case, and while not intending to be bound by the following statement, it is believed that the transition metal compound acts as a catalyst, or part of a catalytic system, in the compositions described herein.

Components B and D: Use of Aluminum Alone and in an Alloy with High Electron Mobility Components

There are several guidelines for selecting the components of the alloys of components B and D of the present invention and their relative proportions, and for determining when aluminum only, i.e. component B without semiconductor material D, is desirable. It is convenient to describe the weight percentages of the aluminum and high electron mobility components in an alloy, without considering any transition metal compound that may later be physically admixed, because the aluminum and high electron mobility components are formed into the alloy prior to being admixing with a transition metal compound.

While not wanting to be bound by the following statement, it is believed that aluminum is the principal component of the composition that reacts to release hydrogen gas upon its contact with the basic solution. Therefore, more hydrogen is generated from the alloy compositions that contain a higher proportion of aluminum. Embodiments designed to maximize the amount of hydrogen gas produced can comprise either compositions with or compositions without the high electron mobility component (D). For example, when substantially pure aluminum (B), in the absence of any high electron mobility component (D), is contacted with a solution of at least one soluble base (C), in the presence of a transition metal compound (A), hydrogen gas is produced. Additionally, when an alloy of from about 5% to about 99% aluminum (B) and 1% to about 95% high electron mobility component (D) is contacted with a solution of at least one soluble base (C), in the presence of a transition metal compound (A), hydrogen gas is also produced.

In an embodiment of the composition of the present invention designed for a slower rate of hydrogen gas release, the weight percent of aluminum can be as low as about 5% of the entire composition by weight. Alloy compositions within the range of about 5% to about 99% aluminum are operative, and the weight percent of aluminum can be adjusted to either maximize hydrogen production or moderate the rate of hydrogen gas release.

A preferred weight percent of aluminum in the alloy of the present invention is therefore from about 10% to about 99% of the entire composition. In an embodiment designed to maximize the amount of hydrogen produced per unit weight of alloy, a more preferred weight percent of aluminum is from about 50% to about 99%, with a more preferred weight percent of from about 80% to about 99% of the alloy. An example of a preferred alloy for maximizing the amount of hydrogen produced is one comprising about 90% aluminum and about 10% germanium.

In an embodiment designed to moderate the rate of hydrogen gas release, a more preferred weight percent of aluminum is from about 5% to about 50% of the alloy composition, with a most preferred weight percent of from about 20% to about 40%. An example of a preferred alloy for moderating the rate of hydrogen production is one comprising about 36% aluminum, about 4% germanium, about 29.1% indium, and about 30.9% antimony.

In embodiments that are especially useful for hybrid fuel cell/battery designs, the weight percent of aluminum in the alloy varies according to the rate of hydrogen release desired for the hybrid fuel cell/battery and the desired high electron mobility components, all of which are known to one skilled in the art. Thus, to increase the amount and rate of hydrogen release, the weight percent of aluminum in the alloy is increased.

If aluminum only is used in the composition of the present invention, then aluminum in any of its widely available forms may be used, which include, but are not limited to, pellet, sheet, foil, foamed, bar, rod, powdered, and combinations thereof. If an aluminum alloy is utilized, the alloy is typically manufactured and processed as outlined below. Once prepared, the aluminum alloy may be fashioned into any desired form for use with the present invention, including, but not limited to, pellet, sheet, foil, foamed, bar, rod, powdered, and combinations thereof.

Component D: High Electron Mobility Component

In selecting the high electron mobility components of the alloys of the present invention, the metallurgical solubility of the high electron mobility component in aluminum may be considered (e.g. from examining phase diagrams). However, as described below, this invention provides methods of making substantially homogeneous alloys, even when the alloy components exhibit low metallurgical solubility in each other.

Furthermore, it has been observed that the electron mobility value of component D is proportional to the rate of hydrogen production, and component D is selected according to the desired rate of hydrogen production. Thus, the lower the electron mobility value of component D, the faster the rate of hydrogen production for a composition containing the same weight percentages of components. The higher the electron mobility value of component D, the slower the rate of hydrogen production for a composition containing the same weight percentages of components.

The alloys of the present invention comprise one or more elements or compounds having high mobility values for electrons. Although these elements or compounds are also referred to herein as semiconductors, the preferred method of characterizing them is with respect to their actual electron mobility values. Semiconductor materials that are operative in the alloys of the present invention include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, Te, and combinations thereof. Table 1 (adapted from the CRC Handbook of Chemistry and Physics, David R. Lide, Editor-in-Chief, CRC Press, 71st Ed., 1990-91) presents the electron mobility values for many of these elements and compounds. The selection of high electron mobility components may be aided by considering their electron mobility values, their compatibility with the other alloy components, their stability in the presence of oxygen, water, and hydrogen, and their relative expense. It is noted that alloy preparation encompasses both the use of the “preformed” semiconductor materials, such as those listed in Table 1, and the use of the individual elemental components of these semiconductors. Thus, an alloy comprising Al, In, and Sb may be prepared from the individual elements, or from Al and indium antimonide (InSb).

TABLE 1
Non-limiting Examples of Elements or Compounds Characterized
by a High Electron Mobility Value

| MATERIAL | ELECTRON MOBILITY (cm²/V · s) |
|---|---|
| C - Carbon | 1800 |
| Si - Silicon | 1900 |
| Ge - Germanium | 3800 |
| Sn - Tin | 2500 |
| AgBr - Silver Bromide | 4000 |
| CdTe - Cadmium Telluride | 1200 |
| HgSe - Mercury Selenide | 20000 |
| HgTe - Mercury Telluride | 25000 |
| AlAs - Aluminum Arsenide | 1200 |
| GaAs - Gallium Arsenide | 8800 |
| GaSb - Gallium Antimonide | 4000 |
| InP - Indium Phosphide | 4600 |
| InAs - Indium Arsenide | 33000 |
| InSb - Indium Antimonide | 78000 |
| SiC - Silicon Carbide | 4000 |
| ZnSiP₂ | 1000 |
| CdSiP₂ | 1000 |
| CdSnAs₂ | 22000 |
| CdIn₂Te₄ | 4000 |
| Hg₅In₂Te₈ | 2000 |
| PbSe - Lead Selenide | 1000 |
| PbTe - Lead Telluride | 1600 |
| Bi₂Te₃ - Bismuth Tritelluride | 1140 |
| Te - Tellurium | 1700 |

While materials having relatively low electron mobilities may be used in the present invention, components having electron mobilities between about 100 cm²/V·s and about 100,000 cm²/V·s are preferred. More preferred are components having electron mobilities between about 400 cm²/V·s and about 100,000 cm²/V·s. More preferred still are those components having electron mobilities between about 800 cm²/V·s and about 100,000 cm²/V·s. Most preferred are elements and compounds having electron mobilities between about 1,000 cm²/V·s and about 80,000 cm² /V·s. High electron mobility elements and compounds selected for this alloy component may be used either by themselves or in combination with additional high electron mobility components. One preferred combination of materials having a high mobility value for elections is Ge and InSb.

Preferred semiconductor materials, include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, Te, and combinations thereof. More preferred semiconductor materials, when using compounds of nickel as the transition metal component of the composition, are Ge, Sn, or InSb. An even more preferred semiconductor material when using compounds of nickel as the transition metal component of the composition, is Ge, or InSb. A most preferred semiconductor material when using compounds of nickel as the transition metal component of the composition is Ge. Note that the semiconductor material selected for the alloys may be used either by itself or in combination with additional high electron mobility components. A preferred combination of semiconductor materials in the alloys is Ge, InSb, and Sn. A more preferred combination of semiconductor materials in the alloys is Ge and InSb.

While not intending to be bound by the following statement, it is believed that the high electron mobility component of the present invention acts as a part of a catalytic system, in the compositions described herein.

Component C: Soluble Base or Soluble Electrolyte

The compositions of the present invention further comprise either at least one soluble base or at least one soluble electrolyte in contact with the aluminum or alloy of aluminum and component C. An aqueous solution of these components is preferred. The selection of component C is made with a particular utility in mind, as the intended use of the composition affects selection of component C. The soluble base or soluble electrolyte are present from about 0.1 molar to about 5 molar concentration. Thus, when the composition is to be employed for the production of hydrogen gas, component C comprises a soluble base in contact with the aluminum or the aluminum alloy. When the composition is to be used as electrode and electrolyte materials in batteries or capacitors, component C comprises a soluble electrolyte in contact with the aluminum or aluminum alloy. When the composition is to be used in fuel cells or hybrid fuel cell/batteries, a soluble base is employed, which serves as both electrolyte and reactant in the fuel cell.

When the composition is to be employed for the production of hydrogen gas, component C is selected such that it comprises a soluble base. The aluminum or aluminum alloy of the present invention is placed in contact with this basic solution to produce hydrogen gas. Soluble hydroxide compounds often selected to fulfill this role, include but not limited to LiOH, NaOH, KOH, RbOH, CsOH, Mg(OH)₂, Ca(OH)₂, Sr(OH)₂, and Ba(OH)₂, even though these compounds have varying solubilities. Potassium hydroxide is a preferred hydroxide compound for the present invention. This invention encompasses the use of slightly soluble hydroxide-containing compounds such as Mg(OH)₂, although the more soluble hydroxides such as alkali metal hydroxides are preferred. Basic compounds other than hydroxides are also useful in the present invention, such as aqueous solutions of Na₂CO₃, K₂CO₃, CaO or NH₃. Each of these compounds forms hydroxide ion when placed in contact with water. Among the non-hydroxide bases in the present invention, potassium carbonate is a preferred soluble base.

When the composition is to be used as electrode and electrolyte materials in batteries, capacitors, and similar devices, component C is selected such that it comprises a soluble electrolyte, which is required for these devices to operate. Aqueous solutions of these materials are typical, and this solution is placed in contact with the aluminum or aluminum alloy, which constitutes an anode in these devices. Thus, when component C comprises a soluble electrolyte, soluble salts such as RbNO₃ and NaNO₃, which constitute neutral salts, are particularly useful. In addition, soluble basic salts are also useful, such as NaOH, KOH, or K₂CO₃. In these latter cases, hydrogen is produced as a byproduct of the battery or capacitor function.

Examples of component C compounds that form electrolyte solutions also include, but are not limited to, the lithium, sodium, potassium, rubidium and/or cesium compounds or salts of the following anions: acetate, bicarbonate, bisulfate, bromide, carbonate, chlorate, chloride, chloroplatinate, chloroplatinite, dihydrophosphate, fluoride, formate, hydrophosphate, hydroxide, iodide, nitrate, nitrite, perchlorate, phosphate, phosphite, sulfate, sulfite, or combinations thereof. Some of these components also form basic solutions in water and therefore are useful in all the applications described herein.

For fuel cell use, component C is selected to function both as an electrolyte and a reactant in the fuel cell. Typically, compounds that provide hydroxide ion in solution meet this role. For example, many fuel cells operate by the reaction of H₂ with OH⁻ at the anode to form H₂O and electrons, thus soluble hydroxide salts such as KOH, and compounds that produce hydroxide ion upon dissolution in water, e.g. K₂CO₃, are especially useful here. While not intending to be bound by the following statement, it is believed that this component functions as both a reactant and an electrolyte. For example, as reactants, KOH and K₂CO₃ are useful for the production of hydrogen or a fuel cell anode reactant when their solutions are placed in contact with the aluminum or aluminum alloy. Additionally, KOH and K₂CO₃ are useful as electrolytes, lowering the internal resistance of a cell and allowing electrons to move between the anode and cathode.

A single component C compound need not be utilized in any given application, but rather more than one compound can be employed. Moreover, compounds that function as one of the reactants in solution, e.g. KOH, can be used in conjunction with other alkali metal compounds that serve merely as electrolytes, e.g. KCl, as combinations of basic and electrolyte compounds. Such a combination is useful in a fuel cell.

The versatility of the present invention is evident, because a single embodiment could be employed for both the production of hydrogen and for use in batteries, capacitors, fuel cells, and similar devices. For example, a soluble base such as KOH(aq) or K₂CO₃(aq) can be used as component C for any of the above utilities, because KOH(aq) also constitutes a soluble electrolyte. However, NaNO₃(aq) can only be used as the soluble electrolyte component C when this invention is used in batteries, capacitors, and related devices, because aqueous NaNO₃ does not provide a basic solution.

An aqueous solution of component C is preferred, and the alkali metal compound may be in solution alone or with the transition metal compound as described above. The concentration of the alkali metal containing materials in solution is a function of the application of the composition, and is readily determined by one skilled in the art of that particular application.

Manufacturing and Processing the Alloys of the Present Invention

An examination of the metallurgical phase diagrams for components and possible components of the aluminum alloys of the present invention suggests that large macrosegregation domains will result from the limited solubilities of these components in their desired percentages. Metallalurgical phase diagrams for these components are reported in Binary Alloy Phase Diagrams, 2d Ed., Vols. 1-3, T. M. Massalski, (ASM International 1990), which is incorporated herein by reference. Therefore, the present invention also provides methods of manufacturing the alloy compositions that reduce macrosegregation and that develop a higher degree of homogeneity than would otherwise be possible.

General Manufacturing Procedures

One concern during the manufacture of the aluminum alloys of the present invention is the introduction of potential contaminants, with special attention directed to preventing the introduction of oxygen or water during the manufacturing process. In order to reduce the presence of contaminants, steps were taken to minimize the exposure of the alloy components to reactants such as air or moisture in order to minimize the formation of oxide, hydroxide, and other contaminants.

Therefore, storage, processing, and manipulation of the alloy components, melts, and final alloys were typically carried out either under vacuum or in an inert atmosphere, such as argon. Methods of handling air- and moisture-sensitive compounds are well known to one of ordinary skill in the art as described in the treatise, The Manipulation of Air-Sensitive Compounds, by D. F. Shriver and M. A. Drezdon, 2d ed., John Wiley and Sons: New York (1986), which is incorporated herein by reference. While there are several methods of handling samples under vacuum or in an inert atmosphere, the components of the present invention were typically handled under argon in an inert atmosphere glove box, such as an Aldrich #Z19,671-1, Z40,3769-2, or Z19,429-8 glove box (Milwaukee, Wis.). When samples were removed from the glove box, transferred to the reaction furnace or chamber, and returned to the glove box after melting, they were typically maintained under an inert atmosphere as much as possible.

The alloys of the present invention can be prepared by melting the alloy components in an arc melting furnace, an induction melting furnace, a vapor deposition chamber, a sintering furnace, or other similar methods that are capable of melting the components of the alloy, such methods being well known to one of ordinary skill in the art. While the particular sample containers and crucibles vary among these methods of melting, in all cases the alloy components, melts, and final alloys were typically manipulated either under vacuum or in an inert atmosphere, such as argon, depending upon the sample container and furnace/chamber design. These methods and practices are well known to one of ordinary skill in the art.

In addition, high purity components were utilized in the present invention to minimize the introduction of existing contaminants in the alloy components that might interfere with the efficient operation of the alloy. While not required to obtain alloy activity, using high purity components enhanced the efficiency of the use of the alloy.

After melting the alloy components, some type of physical agitation or stirring is typically applied to assist in achieving a high degree of homogeneity in the sample. The agitation treatments are made while the sample is still in the liquid state. For example, a high degree of physical agitation of the melt accompanies the arc melting process and, to a lesser extent, induction melting. In the case of arc melting, it is typically not necessary to provide any further agitation steps of any kind beyond that inherent in the process itself. For induction melting, additional agitation is useful, but not necessary.

Commercially available sonication units are employed to sonicate the melts at ultrasonic frequencies. The utility of sonication is illustrated by the formation of an aluminum-lead alloy using ultrasonic techniques, which is difficult to prepare by conventional metallurgical techniques because of the relative insolubilities of these metals in each other. In practice, during both the pre-melt(s) and the final melt of these alloys, high frequency sonication is used during the cooling stage, while the metals/compounds are in a liquid state. With rapid cooling, relatively homogeneous alloys are produced.

An audio frequency agitation process, utilizing either speakers or piezos, is also optionally applied to the liquid sample during the cooling step on both the pre-melt and the final melt, to achieve a high degree of physical agitation. As is known in the art, typical audio frequencies are in the range of from 1 Hz to 32,000 Hz. A wave function generator is connected to a preamplifier which is connected to an audio amplifier, with output either through speakers or piezos, with a power range of from 15 to 30 watts, with more power being applied to larger samples. As in other agitation methods, audio frequency stirring is used on both pre-melts and final melts of the alloys while the sample is still in the liquid state.

The sonication and/or agitation treatments are applied to the alloys while maintaining the samples under an inert atmosphere. While it is not necessary to employ both audio frequency agitation and sonication treatments to every alloy, the ability to impart physical perturbation at different frequencies proves useful to achieve homogeneity for different samples. After cooling is complete such that the sample can be handled safely, the crucible is transferred to an inert atmosphere in a glove box to minimize exposure of the sample to the air during further processing.

Any conventional heat treatment or method known to one skilled in the art to reduce macrosegregation within alloys may be employed to improve homogeneity of the alloy samples of the present invention. As an option, and depending upon the final application of a particular alloy sample, special cooling techniques are utilized to improve the final product. For example, rapid cooling methods, such as pouring the alloy samples over a cold drum, or maintaining the samples in a cold copper crucible, are all practical methods that allow for the rapid cooling of samples, which often provide amorphous as opposed to crystalline samples.

After melting, the gas/vacuum handling system of the particular furnace and crucible is used to place the samples under an inert atmosphere or under vacuum, for further processing. Typically, the samples are transferred back to a glove box for further processing. All post-preparatory procedures, such as machining the alloy samples, weighing the samples, refractory coating of crucibles (if appropriate), and sealing and storing samples in suitable storage containers, are also carried out under an inert atmosphere.

Arc Melting

The arc melting furnace, as used in the present invention, includes a system of melting elements, compounds, and materials through the use of a high current potential being developed between two juxtaposed electrodes. A typical arc melting system includes a vacuum chamber, a cold copper plate/crucible that functions as both an electrode surface and a surface in which the melting is achieved, an upper movable electrode which can be located near the plate/crucible, and a power supply.

The arc melting system of the present invention involves the following steps. The alloy components, which were stored and processed under an inert atmosphere, were loaded into an arc melting crucible and then placed into the vacuum chamber portion of the arc melting furnace with minimal exposure of the sample to the atmosphere. The vacuum chamber was sealed, placed under a dynamic vacuum for several minutes and then refilled with argon. This pump and refill cycle was repeated one or two more times to achieve thorough removal of any remaining gaseous contaminants from the chamber. The upper, moveable electrode was placed into position and the furnace was powered to achieve an arc to meet the sample.

In some alloys it was desirable to form intermediate alloys or “pre-melts” comprising a subset of the alloy components, and thereafter use the intermediate alloy(s) in a subsequent arc melting step along with the remaining alloy components. When pre-melts were used, each pre-melt alloy was handled and processed in the same fashion as a final melt alloy. Thus, after a pre-melt, the intermediate alloy was cooled until it could be handled safely, combined with the remaining alloy components, and then subjected to the arc melting furnace in the same manner. The Examples presented herein illustrate some of the specific pre-melts alloys used in the present invention.

Typically, sufficient physical agitation accompanies the arc melting process to afford the preferred high sample homogeneity. In one embodiment of this invention, an arc melting furnace is fitted with mixing, agitation, or sonication equipment, as described above. After cooling was complete such that the sample could be handled safely, the crucible was transferred to an inert atmosphere in a glove box to minimize exposure of the sample to the air during further processing.

Any conventional heat treatment or method known to one skilled in the art to reduce macrosegregation within alloys may be employed to improve homogeneity of the alloy samples of the present invention.

Induction Melting

As known to one of ordinary skill in the art, induction melting as used in the present invention includes a method of melting materials through the use of a high current, high frequency potential being developed in a copper coil. An insulated crucible, with an example being a graphite tube crucible with a quartz sheath, is placed in the inner diameter of the copper coil. Typical induction melting equipment includes a power supply (4 KHz and above), various diameter copper coils, and glove box/vacuum chambers if necessary.

Induction melting typically involves placing the alloy components in an insulated graphite crucible in a quartz sheath which was then placed in the inner diameter of the copper coils of the induction melting furnace under an inert atmosphere. Melting was accomplished under a blanket of argon gas (1 atmosphere pressure). The induction melting furnace was powered until the sample was completely melted, usually for several minutes depending upon sample size. Power to the furnace was then removed once the sample was allowed to cool until it could be handled safely.

As described above for the arc melting procedure, it is often desirable to prepare pre-melts comprising a subset of the alloy components, and thereafter use the pre-melt alloy in an induction melting step along with the remaining alloy components. When pre-melts were used, each pre-melt alloy was handled and processed in the same fashion as a final melt alloy. The induction melting procedure optionally utilized a series of physical agitation and/or sonication treatments to achieve a high degree of homogeneity in the sample as described above. Any conventional heat treatment or other methods known to one skilled in the art may be utilized to reduce macrosegregation within the alloys, as described above for arc melting.

Vapor Deposition

Vapor deposition, as used in the present invention, refers to methods in which materials are vaporized into the gas phase and then condensed or deposited onto a substrate (such as ceramic, plastic, or glass) through the use of a combination of vaporizing beam and target. As well known to one of ordinary skill in the art, a variety of vapor deposition techniques are available. For example, one vapor deposition technique utilizes an electron beam which strikes a metal target (for example, aluminum) with a known amount of energy, thereby imparting sufficient energy to that target to cause an amount of material to leave the target surface and become a vapor. This vapor is then deposited onto a given substrate at a known thickness and rate.

With respect to the present invention, vapor deposition involves the following steps. First, the alloy components were processed under an inert atmosphere (in a glove box) into the proper form (size, shape, etc.) to constitute a target for the particular vapor deposition equipment being used. Once in the proper form, the vapor deposition target(s) are transferred to the vacuum chamber portion of the deposition equipment, while maintaining the target material under an inert atmosphere to the extent possible. To accomplish this task, the target(s) may simply be packaged in an airtight, argon filled container for transfer to the deposition chamber. The vapor deposition chamber is sealed, a vacuum is created, and the chamber is maintained under a high vacuum during the vapor deposition process.

Just as the pre-melts were desirable in the melting procedures described above, it may be desirable in the vapor deposition process to utilize a series of pre-sputters and alloy layers, before the final sputter. By way of example, in an alloy of the present invention comprising aluminum and germanium, one method of alloy manufacture uses two separate sputtering targets, one target of aluminum and a second target of germanium. During a pre-sputter process, a primer layer of one of these elements is applied to the substrate to yield a desired beneficial effect for the final sample, such as good adhesion to the substrate. Next, the final sputter utilizes both targets to build up a coating of the final alloy. The final sputter step is repeated until the desired thickness of the alloy has been attained.

One advantage of sputtering over conventional metallurgical techniques is that extremely homogeneous samples may be obtained. Because the layers of material applied may be made extremely thin (approximately 100 angstroms) and because the time involved for the sample to cool is extremely rapid, the problems of homogeneity in this alloy system are virtually eliminated. As known to one of ordinary skill in the art, certain treatments and conditioning procedures may be made to the substrate to help insure homogeneity in this alloy system.

A further advantage of sputtering over conventional metallurgical techniques is the ability to apply protective coatings to a final alloy sample. For example, it is often desirable to apply a protective layer to the final alloy sample, for example a silicone layer, to prevent the alloy sample from reacting with the moisture in the ambient air. The vapor deposition process is well adapted to achieve this goal.

Sintering

In addition to the arc melting, induction melting, and vapor deposition techniques described above, the alloys of the present invention may be manufactured by the process of sintering. This method, which is well known to one of ordinary skill in the art, involves thorough mixing of the components of the final alloy, in the proportions desired in the final alloy. The ingredients are mixed in the form of powders until a homogeneous mixture is obtained. Pressure is then applied to a sample of this mixture at pressures from about 10,000 to 100,000 pounds per square inch using, for example, a steel dye. The compressed material is then heated in an oven at sufficiently high temperatures to fuse the alloy.

Use of the Compositions for Electrode/Electrolyte Materials

Battery Anode/Electrolyte Comprising the Composition of the Present Invention

The compositions of the present invention are utilized in a battery that is designed and constructed according to standard battery designs known to one of ordinary skill in the art. Batteries of this design, employing components of the present invention, are capable of achieving high energy densities. The anode of such a battery comprises the aluminum or aluminum alloy compositions of the present invention, and the electrolyte comprises a soluble electrolyte salt or base in solution with the transition metal compound either in solution with salt or base, or admixed with the anode material in solid form. The cathode of the battery comprises any common cathode material, typically carbon, the selection and design of which are well known to one skilled in the art. One example of cathode material that may be used in a battery is the carbon electrode found in zinc-air batteries.

By way of example, the alkali metal compound is typically used as an aqueous solution, although the present invention anticipates the use of solution, paste, and other types of electrolytes known to one of ordinary skill in the art. As an example, potassium carbonate, is used as both the reactant for the alloy and as the intermediary between the anode and cathode in this system. Upon contacting the aluminum or aluminum alloy anode with the electrolyte, the battery is activated. The aluminum or aluminum alloy anode then begin to react with the electrolyte solution and produce hydrogen gas. In this case, however, the hydrogen gas acts as a by-product, and is therefore is used for its role in the release of electrons from the composition. The potential of the electrons generated by the aluminum or aluminum alloy depends upon the components of the alloy.

Capacitor Anode/Electrolyte Comprising the Composition of the Present Invention

The composition of the present invention may also be used in a capacitor/battery device of similar design as hybrid capacitor/battery devices in the relevant art, to achieve high energy densities. In such devices, the anode of this capacitor/battery is typically made of a combination anode comprising the aluminum or aluminum alloy of the present invention and high surface area carbon foams as used in super capacitor or ultra capacitor technologies known to one of ordinary skill in the art.

The composite is constructed such that samples of anode material and carbon foam materials are brought into intimate contact along one edge of each material, such that a single monolith comprising two portions is formed. Alternatively, a carbon foam electrode that is impregnated with aluminum or the aluminum alloy composition of the present invention may be employed. One carbon foam employed in such capacitor devices is manufactured by Mitsushita (Kyoto, Japan) and utilized in the Panasonic super capacitor EECA OEL 106 rated at 2.5V at 10 farads. The cathode of the capacitor comprises any common cathode material, typically carbon, the selection and design of which are well known. One example of cathode material is the carbon electrode found in zinc-air batteries. A dielectric material separating the anodic and cathodic half-cells is typically used, depending upon the particular capacitor design.

An electrolyte comprising the aqueous alkali metal hydroxide or carbonate is typically used, although the present invention anticipates the use of solution, paste, and other types of electrolytes known to one of ordinary skill in the art. The transition metal compound is either in the solution or paste with the alkali metal, or admixed with the anode material in solid form. As an example, a potassium carbonate electrolyte is used as both the reactant for the alloy and as the intermediary between the anode and cathode in this system. Depending on cell configuration, a dialectric may or may not be used. Upon contacting the potassium carbonate electrolyte with the aluminum or aluminum alloy anode, hydrogen gas is produced. In this case, however, the hydrogen gas acts as a by-product, and, therefore, is used for its role in the release of electrons from the composition. The potential of the electrons generated by the aluminum or aluminum alloy depends upon the components of the alloy.

The difference between the battery and the capacitor hybrid is that electrons from the alloy begin to accumulate along the surface of the carbon foam. Due to the high surface area of the carbon foam material and its operating characteristics, a high peak current is possible when discharging this device through a load. This hybrid capacitor device, like a capacitor, may be recharged from an external power source, however, this capacitor hybrid recharges itself over time as a result of the battery incorporated within its design.

Fuel Cell and Hybrid Battery/Fuel Cell Comprising the Composition of the Present Invention

The compositions of the present invention are utilized in a hybrid battery/fuel cell that is designed and constructed according to standard fuel cell designs known to one skilled in the art, to achieve high energy densities. The anode of the fuel cell is constructed in one of two ways. In one embodiment, the anode comprises the aluminum or aluminum alloy composition of the present invention, in contact with a standard platinum black electrode. Moreover, these two anode components are disposed where the hydrogen gas produced at the aluminum or aluminum alloy portion of the anode contacted the platinum black portion of the anode and thereby serves as a fuel for the fuel cell. In a second embodiment, the anode comprises the aluminum or aluminum alloy of the present invention, wherein the alloy also contains platinum metal as one of its components. Thus, the platinum serves to convert the hydrogen to water in the operation of the fuel cell.

The cathode of the fuel cell comprises any common fuel cell cathode material, the selection and design of which are well known to one of ordinary skill in the art. The cathode is contacted with oxygen which comprises the oxidant for the fuel cell system and is itself reduced to hydroxide during the operation of the fuel cell. An aqueous electrolyte comprising an alkali metal compound is used in this system, with the transition metal compound either in the solution with the alkali metal, or admixed with the anode material in solid form. In embodiments designed for the production of hydrogen for operation of a standard fuel cell, or in hybrid fuel cell/batteries that depend upon the production of hydrogen, the alkali metal compound provides a basic solution when dissolved in water for reaction with the aluminum or aluminum-semiconductor alloy of the composition.

When the aluminum or aluminum alloy anode of the present invention comes into contact with the aqueous electrolyte, reaction between the electrolyte and the alloy initiates, and hydrogen is produced. The hydrogen is used in the direct production of energy in this fuel cell system, thus hydrogen is oxidized at the anode and oxygen is reduced at the cathode.

The reaction systems of the present invention were also utilized in conjunction with a traditional fuel cell designs by employing them solely as a source for hydrogen gas. Thus, upon contacting the alloy compositions of the present invention with basic solutions, hydrogen gas was produced that was utilized by contacting it with the anode of a traditional hydrogen fuel cell system.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to one of ordinary skill in the art without departing from the spirit of the present invention or the scope of the appended claims.

### EXAMPLE 1

Preparation and Utility of a Composition for Generating Hydrogen Gas

A composition of the present invention, comprising nickel hydroxide (Ni(OH)₂, Aldrich Chemical Company, Milwaukee, Wis.), aluminum, and potassium carbonate (K₂CO₃), and designed for the generation of hydrogen gas was prepared as follows. A potassium carbonate solution was prepared by dissolving 1.0 g of potassium carbonate in about 700 mL of distilled water. To this solution was added 0.5 g of nickel hydroxide. The controlled production of hydrogen gas was effected by adding 1.0 g of 1.0 mm diameter aluminum pellets in contact with the K₂CO₃/Ni(OH)₂ solution. The hydrogen gas generated from this composition was collected over a period of several days.

### EXAMPLE 2

Preparation and Utility of a Composition for Powering a Fuel Cell

A composition of the present invention, comprising nickel hydroxide (Ni(OH)₂), aluminum, and potassium carbonate (K₂CO₃), designed to generate hydrogen gas to power a fuel cell, was prepared as follows. A potassium carbonate solution was prepared by dissolving 1.0 g of potassium carbonate in about 700 mL of distilled water. A sample of 0.5 g of nickel hydroxide was admixed with 1.0 g of 1.0 mm diameter aluminum pellets, and this mixture rolled inside a section of filter paper. This Al/Ni(OH)₂ mixture was placed in contact with the K₂CO₃ solution, whereupon hydrogen gas was generated and collected over a period of several days. Hydrogen production was confirmed by adding a sample of the composition to a fuel cell (VWR, Atlanta, Ga., Scientific Mini Fuel Cell # WLS30198), contacting the alloy with distilled water, and using a voltmeter to confirm a potential of 1 V across the cell in a no-load configuration. The fuel cell anode was also placed in contact with the generated gas and a resistance of 44 ohm was placed across the fuel cell in a conventional fashion. The gas generated by this system was sufficient to power the cell.

### EXAMPLE 3

Preparation and Utility of a Composition for Generating Hydrogen Gas

A composition of the present invention, comprising nickel hydroxide (Ni(OH)₂), aluminum, and potassium hydroxide (KOH), and designed for the generation of hydrogen gas was prepared as follows. A potassium hydroxide solution was prepared by dissolving about 6.24 g of potassium hydroxide in about 700 mL of distilled (or deionized) water. To this solution was added 0.5 g of nickel hydroxide. The controlled production of hydrogen gas was effected by adding 1.0 g of 1.0 mm diameter aluminum pellets in contact with the KOH/Ni(OH)₂ solution. The hydrogen gas generated from this composition was collected over a period of several days.

### EXAMPLE 4

Preparation of an Aluminum Alloy Composition by Arc Melting for Use in the Composition

In order to reduce the presence of contaminants in the alloys of the present invention, steps were taken to minimize the exposure of the alloy components to reactants such as air and moisture. In addition, whenever possible, high purity components were utilized in the present invention to minimize the introduction of existing contaminants from the individual alloy components that might interfere with the efficient operation of the alloy.

An arc melting crucible was loaded with about 90 g of aluminum and 10 g of germanium. The crucible was then transferred to the vacuum chamber of the arc melting furnace with minimal exposure of the sample to the atmosphere. The vacuum chamber was placed under a dynamic vacuum for several minutes, and then refilled with argon. This pump and refill cycle was repeated one or two more times to achieve thorough removal of any remaining gaseous contaminants from the chamber. The upper, moveable electrode was placed into position, and the furnace was powered to achieve an arc to melt the sample. Typical power supplies used in this experiment provided approximately 2,000 amps. The moveable electrode was slowly and continuously moved around the sample to facilitate melting and up to a minute thereafter to facilitate mixing.

Next, power to the furnace was shut off and the sample was allowed to cool for several minutes until it could be handled safely. After cooling was complete, the crucible was transferred to an inert atmosphere glove box or stored under vacuum to minimize exposure of the sample to the atmosphere until further processing.

Small alloy samples of about 1 g were cut from the bulk alloy sample produced in this fashion. These smaller samples were used to generate hydrogen as described in Example 1, and to power a fuel cell as in Example 2, where a voltmeter was used to confirm a potential of 1 V across the cell.

### EXAMPLE 5

Preparation of an Alloy Composition by Arc Melting for Use in the Composition Using Pre-Melts

In some embodiments of this invention, it was desirable to form intermediate alloys comprising a subset of the alloy components, and thereafter use this intermediate alloy in a subsequent arc melting step along with the remaining alloy components. This example illustrates the use of such an intermediate alloy or “pre-melt” of aluminum and germanium.

In an inert atmosphere dry box, an arc melting crucible was loaded with 36 g of aluminum and 4 g of germanium. This sample was handled and melted in the manner described in Example 4. After cooling, the intermediate aluminum-germanium alloy, which appeared homogeneous, was combined with the remaining alloy components, 29.1 g of indium and 30.9 g of antimony, and then melted in the arc melting furnace in the same manner described in Example 4. Further processing was carried out as outlined in Example 4.

Small alloy samples of about 1 g were cut from the bulk alloy sample produced in this fashion. These smaller samples were used to generate hydrogen as described in Example 1, and to power a fuel cell as in Example 2, where a voltmeter was used to confirm a potential of 1 V across the cell.

### EXAMPLE 6

Preparation of an Alloy Composition by Arc Melting for Use in the Composition Using Pre-Melts

This example illustrates the preparation of an alloy comprising aluminum and a high electron mobility component, by preparing two intermediate alloys or “pre-melts”. The alloy components of this example comprise 36 g of aluminum, 4 g of germanium, 29.1 g of indium, and 30.9 g of antimony. This method of alloy manufacture consists of first making a pre-melt alloy of indium and antimony, then making a second pre-melt alloy of aluminum and germanium, and a final melt of the indium-antimony alloy and the aluminum-germanium alloy, all according to the techniques outlined in Example 5.

### EXAMPLE 7

Preparation of an Alloy Composition by Arc Melting for Use in the Composition Using Pre-Melts

This example illustrates the preparation of an alloy comprising aluminum and a high electron mobility component, by preparing two intermediate alloys or “pre-melts”. The alloy components of this example comprise 19.7 g of aluminum, 3.5 g of germanium, 18.8 g of indium, 20 g of antimony, and 38 g of tin. This method of alloy manufacture consists of first making a pre-melt alloy of indium and antimony, then making a second pre-melt alloy of aluminum and germanium, and a final melt of the indium-antimony alloy, the aluminum-germanium alloy, and tin, all according to the techniques outlined in Example 5.

### EXAMPLE 8

Preparation and Utility of a Composition in a Battery Configuration

Any of the compositions of the present invention are utilized in a battery that is designed and constructed according to standard battery designs known to one of ordinary skill in the art, to achieve high energy densities.

The anode of the battery comprises either aluminum or the aluminum/semiconductor alloy composition of the present invention. The cathode of the battery comprises any common cathode material, typically carbon, the selection and design of which are well known. One example of cathode material is the carbon electrode found in zinc-air batteries. In this Example, the composition comprises nickel hydroxide, aluminum, and potassium carbonate. The transition metal compound may be added directly to the electrolyte solution, even though the solubility of Ni(OH)₂ in water is slight. Typically, however, the transition metal compound is placed in intimate contact or admixed in solid form with the aluminum.

The electrolyte, here potassium carbonate, is used as both the reactant for the alloy and as the intermediary between the anode and cathode in this system. Depending on cell configuration, a media separator may or may not be used. An “activation strip” of insulator material is removably attached along one surface of the alloy anode to prevent contact between the alloy anode and the electrolyte of the battery before the battery is ready for use. This insulator material is then removed to allow contact between the anode and the electrolyte and thereby activate the battery.

Upon removal of the activation strip, the aluminum (or aluminum alloy) anode, comes into contact with the potassium carbonate electrolyte. The aluminum alloy anode then begins to react with the electrolyte solution and produce hydrogen gas. In this case, however, the hydrogen gas acts as a by-product, and therefore is used for its role in the release of electrons from the composition. The potential of the electrons generated by the aluminum or aluminum alloy depends upon the components of the alloy.

In order to prevent the electrolyte from drying out as a result of the reaction of the electrolyte solution with the alloy, a means for oxidizing the hydrogen gas produced within this system is provided within the battery. Any of the well-known methods disclosed in the prior art may be utilized for this purpose. One such method is to use a platinum coated surface to allow the platinum to convert the hydrogen to water catalytically, in the presence of ambient oxygen. Another method employs a small amount of platinum into the alloy itself, obviating the need for any additional structures within the battery enclosure. Another method utilizes a material other than platinum, such as silver oxide, as described in the prior art.

### EXAMPLE 9

Preparation and Utility Composition in a Hybrid Capacitor/Battery Configuration

Any of the compositions of the present invention is useful in a capacitor/battery device of similar design to the hybrid capacitor/battery devices in the relevant art, to achieve high energy densities. In such devices, the anode of this capacitor/battery is made of a composite of either aluminum or the aluminum alloy of the present invention and high surface area carbon foams as used in super capacitor or ultra capacitor technologies known to one skilled in the art. The composite is constructed such that samples of alloy and carbon foam materials are brought into intimate contact along one edge of each material, such that a single monolith comprising two portions is formed. Alternatively, a carbon foam electrode that is impregnated with aluminum or the aluminum alloy composition of the present invention may be employed. One carbon foam employed in such capacitor devices is manufactured by Mitsushita (Kyoto, Japan) and utilized in the Panasonic super capacitor EECA OEL 106 rated at 2.5V at 10 farads.

The cathode of the capacitor comprises any common cathode material, typically carbon, the selection and design of which are well known. One example of cathode material is the carbon electrodes found in zinc-air batteries. A dielectric material separating the anodic and cathodic half-cells is typically used, depending upon the particular capacitor design.

In this Example, the composition comprises nickel hydroxide, aluminum, and potassium carbonate. The transition metal compound is typically placed in intimate contact or admixed with the aluminum in solid form.

The electrolyte, here potassium carbonate, is used as both the reactant for the alloy and as the intermediary between the anode and cathode in this system. Depending on cell configuration, a dialectric may or may not be used. An “activation strip” of insulator material is removably attached along one surface of the alloy anode to prevent contact between the alloy anode and the electrolyte of the capacitor/battery before it is ready for use. This insulator material is then removed to allow contact between the anode and the electrolyte and thereby activate the capacitor/battery.

Upon removal of the activation strip, the aluminum (or aluminum alloy) anode, comes into contact with the potassium carbonate electrolyte. The aluminum alloy anode then begins to react with the electrolyte solution and produce hydrogen gas. In this case, however, the hydrogen gas acts as a by-product, and is therefore is used for its role in the release of electrons from the composition. The potential of the electrons generated by the aluminum or aluminum alloy depends upon the components of the alloy.

In order to prevent the electrolyte from drying out as a result of the reaction of the electrolyte solution with the alloy, a means for oxidizing the hydrogen gas produced within this system is provided within the capacitor/battery. For example, one method to achieve this effect is to use a platinum coated surface or platinum mesh to allow the platinum to convert the hydrogen to water catalytically, in the presence of ambient oxygen. Another method employs a small amount of platinum into the alloy itself, obviating the need for any additional structures within the capacitor enclosure. Another method utilizes a material other than platinum, such as silver oxide, as described in the prior art.

The difference between the battery of Example 8 and the capacitor hybrid of this Example is that electrons from the alloy begin to accumulate along the surface of the carbon foam. Due to the high surface area of the carbon foam material and its operating characteristics, a high peak current is possible when discharging this device through a load. This hybrid capacitor device, like a capacitor, may be recharged from an external power source, however, this capacitor hybrid will also recharge itself over time as a result of the battery incorporated within its design.

### EXAMPLE 10

Composition in a Fuel Cell Electrode and as a Fuel Source in a Hybrid Battery/Fuel Cell

The composition of Example 1 of the present invention is utilized in a hybrid battery/fuel cell that is designed and constructed according to standard fuel cell designs known to one skilled in the art, to achieve high energy densities. The anode of the fuel cell is constructed in one of two ways. In one embodiment, the anode comprises the aluminum or aluminum alloy composition of the present invention, in contact with a standard platinum black electrode. Moreover, these two anode components are disposed where the hydrogen gas produced at the alloy portion of the anode contacts the platinum black portion of the anode and thereby serves as a fuel for the fuel cell. In a second embodiment, the anode comprises the aluminum alloy of the present invention, wherein the alloy also contains platinum as one of its components. Thus, the platinum serves to convert the hydrogen to water in the operation of the fuel cell.

The cathode of the fuel cell comprises any common fuel cell cathode material, the selection and design of which are well known. The cathode is contacted with oxygen that constitutes the oxidant for the fuel cell system and is itself reduced to hydroxide during the operation of the fuel cell. An aqueous electrolyte comprising an alkali metal compound is used in this system. The transition metal compound is typically placed in intimate contact or admixed with the aluminum in solid form.

An “activation strip” of insulator material is removably attached along one surface of the aluminum alloy anode to prevent contact between the alloy anode and the electrolyte of the fuel cell before it is ready for use. This insulator material is removed to allow contact and thereby activate the fuel cell. Upon removal of the activation strip, the alloy anode of the present invention comes into contact with the aqueous electrolyte, reaction initiates between the electrolyte and the alloy, and hydrogen is produced. The hydrogen is used in the direct production of energy in this fuel cell system, thus hydrogen is oxidized at the anode and oxygen is reduced at the cathode.

This fuel cell system comprises an inherent method to prevent the electrolyte from drying out as a result of the reaction of the electrolyte solution with the alloy, namely, an internal means for oxidizing the hydrogen gas produced within the system.

In another embodiment, the composition comprises nickel hydroxide, aluminum, and rubidium carbonate, and is used according to the teachings of this example.

### EXAMPLE 11

Composition of Compositions of the Present Invention Utilized for Energy Production

The following listing, Table 2, provides several examples of compositions of the present invention, comprising: (A) one or more transition metal compounds; (B) aluminum; and (C) either at least one soluble base or at least one soluble electrolyte in contact with the aluminum. Table 2 also provides examples of compositions of the present invention comprising: (A) one or more transition metal compounds; (B) aluminum; (C) either at least one soluble base or at least one soluble electrolyte in contact with the aluminum; and (D) one or more elements and/or compounds having high mobility values for electrons, in some applications. Weight percentages are tabulated only for the components of the alloy of the present invention, that is, for embodiments comprising both components B and D. In those embodiments that do not comprise component D, the composition comprises substantially pure aluminum in place of an alloy of components B and D.

The concentrations or weight percentages of the transition metal compound and the alkali metal compound are not listed. The alkali metal compound may be in solution alone or with the transition metal compound. The concentration of the alkali metal containing materials in solution is a function of the application of the composition, and is readily determined by one skilled in the art of that particular application. The transition metal compound may be added directly to the electrolyte solution, or placed in intimate contact or admixed with the aluminum or the aluminum alloy in solid form. Therefore, Table 2 indicates the selection of components for the composition of the present invention, and the weight percentages of alloy components.

TABLE 2
Components

| A | | C | D |
|---|---|---|---|
| Transition Metal | B | Base or | High Electron |
| Compound | Aluminum | Electrolyte | Mobility Component |
| Ni(OH)₂ | Al | K₂CO₃ | — |
| Ni(OH)₂ | Al | KOH | — |
| Ni(OH)₂ | Al | RbNO₃ | — |
| Ni(OH)₂ | Al | NaNO₃ | — |
| Ni(OH)₂ | Al | Rb₂CO₃ | — |
| Ni(OH)₂ | Al 90% | K₂CO₃ | Ge 10% |
| Ni(OH)₂ | Al 90% | KOH | Ge 10% |
| Ni(OH)₂ | Al 36% | RbNO₃ | Ge 4% |
| | | | In 29.1% |
| | | | Sb 30.9% |
| Ni(OH)₂ | Al 40% | NaNO₃ | In 29.1% |
| | | | Sb 30.9% |
| Ni(OH)₂ | Al 19.7% | Rb₂CO₃ | Ge 3.5% |
| | | | In 18.8% |
| | | | Sb 20% |
| | | | Sn 38% |

### EXAMPLE 12

Processing an Alloy Composition in Powder Form

Any of the aluminum or aluminum alloy compositions used in the Examples above can be processed from the block form into powder. Processing the alloys into powder provides a sample with much greater surface area, thereby greatly increasing the amount of hydrogen gas that is produced upon exposure of the aluminum or aluminum alloy to the solution of alkali metal compound.

Samples of the aluminum or aluminum alloy compositions used in the Examples above can be processed into powder form using standard techniques well known to one of ordinary skill in the art. Thus, samples of 100 mesh, 400 mesh, 3 micron, and smaller can be formed. Each of these samples can be used to generate hydrogen gas as provided in Example 1. The 100 mesh powder produces more hydrogen gas than the same amount of alloy in block form. The 400 mesh powder produces more hydrogen gas than the same amount of 100 mesh alloy. The 3 micron powder alloy produces even more hydrogen than the 100 or 400 mesh samples.

It should be understood, of course, that the foregoing relates only to preferred embodiments of the present invention and that numerous modifications and alterations may be made therein without departing from the spirit and the scope of the invention. In particular, one skilled in the art will understand the amount and relative proportions of components used in the compositions of the present invention, as well as operating parameters for using these compositions in their various applications.

What is claimed is:

1. A composition comprising:
at least one transition metal compound;
aluminum; and
a solution comprising at least one base or at least one electrolyte.

2. The composition of claim 1, wherein the transition metal compound is a compound of iron, ruthenium, osmium, cobalt, rhodium, iridium, nickel, palladium, platinum or combinations thereof.

3. The composition of claim 1, wherein the base is LiOH, NaOH, KOH, RbOH, CsOH, Mg(OH)₂, Ca(OH)₂, Sr(OH)₂, Ba(OH)₂, Na₂CO₃, K₂CO₃, CaO, or NH₃, or combinations thereof.

4. The composition of claim 1, wherein the base or the electrolyte is present in solution at a concentration from about 0.1 molar to about 5 molar.

5. The composition of claim 1, wherein the at least one transition metal compound is in solution.

6. The composition of claim 1, wherein the at least one transition metal compound is admixed with the aluminum.

7. A composition comprising:
at least one transition metal compound;
an alloy comprising aluminum and at least one high electron mobility component; and
a solution comprising at least one base or at least one electrolyte in contact with the alloy.

8. The composition of claim 8, wherein the transition metal compound is a compound of iron, ruthenium, osmium, cobalt, rhodium, iridium, nickel, palladium, platinum or combinations thereof.

9. The composition of claim 8, wherein the base is LiOH, NaOH, KOH, RbOH, CsOH, Mg(OH)₂, Ca(OH)₂, Sr(OH)₂, Ba(OH)₂, Na₂CO₃, K₂CO₃, CaO, or NH₃, or combinations thereof.

10. The composition of claim 8, wherein the at least one transition metal compound is in solution.

11. The composition of claim 8, wherein the at least one transition metal compound is admixed with the alloy.

12. The composition of claim 8, wherein the high electron mobility component is C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, or Te, or combinations thereof.

13. The composition of claim 8, wherein the at least one high electron mobility component is provided in an amount from about 1% to about 95% of the alloy by weight.

14. A method of producing hydrogen gas comprising the steps of:
providing the composition of claim 1, wherein the at least one base is in aqueous solution; and
contacting the aluminum with the aqueous solution.

15. A method of producing hydrogen gas comprising the steps of:
providing the composition of claim 1, wherein the at least one base and the at least one transition metal compound are in aqueous solution; and
contacting the aluminum with the aqueous solution.

16. A method of producing hydrogen gas comprising the steps of:
providing the composition of claim 8, wherein the at least one base is in aqueous solution; and
contacting the alloy with the aqueous solution.

17. A method of producing hydrogen gas comprising the steps of:
providing the composition of claim 8, wherein the at least one base and the at least one transition metal compound are in aqueous solution; and
contacting the alloy with the aqueous solution.

18. A method of manufacturing the alloy of claim 8, comprising the steps of:
providing the aluminum and the at least one high electron mobility component as ingredients;
melting the ingredients to form a mixture; and
cooling the mixture until the mixture solidifies.

19. A battery comprising an anode, a cathode, and an electrolyte, wherein the anode and the electrolyte comprise the composition of claim 1.

20. A battery comprising an anode, a cathode, and an electrolyte, wherein the anode and the electrolyte comprise the composition of claim 8.

21. A capacitor comprising an anode in contact with a sample of carbon foam, a cathode, an electrolyte, and a dielectric, wherein the anode and the electrolyte comprise the composition of claim 1.

22. A capacitor comprising an anode in contact with a sample of carbon foam, a cathode, an electrolyte, and a dielectric, wherein the anode and the electrolyte comprise the composition of claim 8.

23. A fuel cell comprising an anode, a cathode, and an electrolyte, wherein the anode and the electrolyte comprise the composition of claim 1.

24. A fuel cell comprising an anode, a cathode, and an electrolyte, wherein the anode and the electrolyte comprise the composition of claim 8.

25. A fuel cell assembly comprising a hydrogen fuel cell and a hydrogen generator, wherein the hydrogen generator comprises the composition of claim 1 and water.

26. A fuel cell assembly comprising a hydrogen fuel cell and a hydrogen generator, wherein the hydrogen generator comprises the composition of claim 8 and water.
